(19) United States
(12) Patent Application Publication
(10) Pub. No.: US 2006/0147699 A1
(43) Pub. Date: Jul. 6, 2006

(54) Protective ceramic coating

(75) Inventors: Partho Sarkar, Edmonton (CA); Lorne Johanson, Edmonton (CA); Florin Esanu, Edmonton (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Alberta Research Council Inc., Edmonton (CA)

(21) Appl. No.: 10/528,752

(22) PCT Filed: Oct. 3, 2003
(86) PCT No.: PCT/CA03/01520

§ 371 Date: Jan. 17, 2006

Related U.S. Application Data
(60) Provisional application No. 60/415,466, filed on Oct. 3, 2002.

(51) Int. Cl. B32B 5/16

(52) U.S. Cl. 428/323; 427/180; 427/402

(57) ABSTRACT

This invention relates to a composite coating for protection of metal, glass and ceramic substrates and a method of producing same. The coating process consists of: depositing a ceramic porous coating made of a ceramic filler and a binding phase consisting of a finely divided glass and a ceramic sol; sintering the coating by a heat treatment up to 700° C.; and, optionally sealing the porous ceramic coating with an inorganic sealant or an organic sealant, or a combination thereof.

### FIELD OF THE INVENTION

This invention relates generally to protective coatings, and in particular to a ceramic-containing coating for protecting a substrate.

### BACKGROUND OF THE INVENTION

Ceramic coatings have been used to protect substrate materials from erosion, corrosion and high temperatures. Known techniques to prepare such protective ceramic coatings include plasma spraying, physical vapor deposition (PVD) and chemical vapor deposition (CVD). In plasma spraying, a ceramic bulk powder is passed through plasma and then directed towards a substrate for deposition. Ceramic films up to about 10 mm thick can be produced with this technique. Post-deposition sealing treatment is usually carried out as the ceramic films tends to be porous.

CVD and PVD tend to be relatively expensive processes, or require a large investment. There have been attempts to develop alternatives to these techniques that are less expensive, have similar or improved protective properties, and have versatility in their application. One group of such alternative ceramic coating technologies is colloidal processing, which applies a ceramic coating onto a substrate by conventional methods such as painting, spraying and spin-casting.

Known colloidal processes typically involve producing a ceramic coating comprising a ceramic filler in a ceramic matrix. However, known colloidal processes have certain deficiencies, such as lengthy and complex process steps, use of hazardous or expensive materials, or limited applications. For example, U.S. Pat. No. 5,585,136 (Barrow et al.) discloses a modified sol-gel technique for deposition of ceramic coatings on selected substrates. In particular, a sol-gel solution is loaded with up to 90% by weight of finely divided ceramic particles and then mixed. The resulting slurry or paint can be either spun, dip-coated, sprayed or painted onto a planar or other substrate, fired to remove the organic materials and to develop a microcrystalline structure. The fired film may then be heated. The sol-gel films disclosed in Barrow et al. may be susceptible to substrate interaction, and may develop defects and stresses within the film coating. Furthermore, the films as taught by Barrow et al. tend to be difficult to apply in thicknesses exceeding 10 microns, and therefore require multiple applications to produce a usefully thick protective coating.

U.S. Pat. No. 6,284,682 (Troczynski et al.) discloses another sol-gel-based colloidal processing technique that employs chemical bonding through phosphating of sol-gel derived oxides or hydrated oxides and polymerizing the phosphated product with heat treatment. The Trocynski et al. technique requires separate application of sol and phosphoric acid treatments; such separate application tends to be difficult to control precisely on an industrial scale. Furthermore, the chemicals used in this disclosed technique tend to be highly toxic and corrosive, which create safety concerns and result in increased handling costs.

U.S. Pat. No. 5,626,923 (Fitzgibbons et al.) discloses a coating composition consisting of a putty-like material comprising a colloidal silica, a base for gelling the silica, a filler, and no more than 50 wt. % of a volatile solvent or solvents. The putty-like material is rolled onto the desired ceramic or metallic substrate and cured to form a protective ceramic coating of a desired thickness. The cured coating may be fired, if desired. However, the technique taught in this patent produces a gelled silica that appears difficult or impossible to apply onto certain non line-of-sight geometry components such as the inside of tubes, threaded parts etc. by known techniques, such as spraying, dip-coating and spin-casting.

It is therefore desirable to provide a coating and a method of producing such a coating that overcomes at least some of the known disadvantages and deficiencies of the prior art. In particular, it is desirable to provide a coating having useful protective properties, that can be produced by a colloidal processing technique that has none or at least fewer deficiencies than existing colloidal processing techniques.

### SUMMARY OF THE INVENTION

According to one aspect of the invention, there is provided a ceramic coating for protecting a substrate. The coating comprises a ceramic matrix formed by a high temperature interaction between fine vitreous particles and the solid content of a ceramic liquid precursor, such as the solid component of a ceramic sol; and a filler comprising one or more materials selected from the group of ceramic, glass, and metal particles, the filler being integrated in the matrix.

The fine vitreous particles may be glass particles having an average particle size of 5 μm or less. These glass particles may be selected from the group of lithium sodium borosilicate glass and glasses containing SiO₂ Al₂O₃, B₂O₃, P₂O₃, ZrO₂ and TiO₂. For glass particles that are lithium sodium borosilicate glass, the glass particles may also contain up to 10 wt % additions of one or more oxides selected from the group of Fe, Ni, Co, V, Sb, P and Mn.

The ceramic sol precursor may be selected from the group of ceramic sols of alumina, silica, titania, zirconia, and mixtures thereof. The filler material may be selected from the group of ceramic particles consisting of alumina, silica, titania, magnesia spinel, B₄C, BN, SiC, AlN, Sialon, and mixtures thereof, and from the group of metallic particles consisting of aluminum, stainless steel, and nickel alloys.

According to another aspect of the invention, there is provided a composite coating for protecting a substrate that comprises the ceramic coating described above, and a sealant penetrating at least the surface layer of the ceramic coating. The sealant may be an inorganic material derived from a liquid ceramic precursor; the ceramic precursor is selected from the group of sodium borate, boric acid, mixed borophosphates, and, mixtures of ceramic sols and silica sols sodium borate, boric acid, and mixed borophosphates. Alternatively, the sealant may be an organic polymer containing at least one resin selected from the group of polytetrafluoroethylene (PTFE), tetrafluoroethylene-perfluorovinyl ethers copolymers, fluorinated ethylene-propylene copolymers, low density polyethylene, poly ether sulfone, polyimide, and epoxy resins.

According to yet another aspect of the invention, there is provided a method of producing a protective ceramic coating and applying the coating onto a substrate. In this method, a preparation is formed by mixing together fine vitreous particles, a liquid carrier, and filler particles selected from the group of ceramic, glass, and metal particles. Then, the preparation is applied onto a substrate to form a coating on the substrate. Then, the coating is heated until the coating has sufficient integrity to be coated with a ceramic sol. Then, a ceramic sol is applied onto the coating such that the sol penetrates the pores of the coating. Then, the coating is heated under conditions sufficient to cause an interaction between the fine vitreous particles and the solid component of the ceramic sol, thereby forming a ceramic matrix with filler particles integrated therein.

In the first heating step (“pre-sintering step”), the coating may be heated under conditions sufficient to provide the coating with enough mechanical strength for dip-coating. If so heated, the coating may then be dip-coated in a liquid bath of the ceramic sol so that the ceramic sol penetrates the pores of the coating. Alternatively, the preparation may be mixed until it is suitable for spraying, and then the preparation is sprayed on the substrate.

In the first heating step, the coating may be heated at between 300-850° C. In the second heating step, the coating may be heated at between 550-850° C. More particularly, the coating may be heated at a temperature between 650-850° C. and under conditions sufficient to sinter the coating.

According to another aspect of the invention, there is provided a method of forming a composite coating that first involves forming a ceramic coating as described above, then applying a sealant onto the ceramic coating such that the sealant penetrates at least the surface layer of the coating, then, heating the coating at a temperature sufficient to bond the sealant to the ceramic matrix. The sealant may be in liquid form and if so, may be applied to the coating by one of dip-coating or spraying. Alternatively, the sealant may be applied to the coating by one of powder coating, spray-coating, dip-coating, and spin-coating.

According to another aspect of the invention, there is provided another method of producing a protective ceramic coating and applying the coating onto a substrate. In this method a preparation is formed by mixing together a ceramic sol, a sufficient amount of pH modifier agent to prevent gelation of the sol, and filler particles selected from the group of ceramic, glass, and metal particles. Then, fine vitreous particles are mixed into the preparation. Then, the preparation is applied onto a substrate to form a coating on the substrate. Then, the coating is heated under conditions sufficient to cause an interaction between the fine vitreous particles and the solid component of the ceramic sol, thereby forming a ceramic matrix with filler particles integrated therein.

The coating may be heated at between 550-850° C. More particularly, the coating may be heated at between 650-850° C. under conditions sufficient to sinter the coating.

The preparation may be applied to the substrate by spin-coating. Or, the coating may be applied by one of spraying or dip-coating, in which case, additional liquid carrier is first applied to the preparation to dilute the preparation, before spraying or dip-coating.

A sealant may be applied onto the coating such that the sealant penetrates at least the surface layer of the coating. Then, the coating is heated at a temperature sufficient to bond the sealant to the ceramic matrix. The sealant may be in solution form and be applied to the coating by one of dip-coating or spraying. Alternatively, the sealant may be applied to the coating by one of powder coating, spray-coating, dip-coating, and spin-coating.

### BRIEF DESCRIPTION OF THE DRAWINGS

FIG. 1 is a flowchart illustrating one method of producing a ceramic coating wherein a ceramic sol is mixed in a separate step with glass and filler particles.

FIG. 2 is a flowchart illustrating another method for producing a ceramic coating wherein a ceramic sol and glass particles are mixed in a single step.

FIG. 3 is a Scanning Electron Microscopy (SEM) image of a pair of metal substrates coated with a protective ceramic coating.

FIG. 4 is a Scanning Electron Microscopy (SEM) image of a composite polymer-ceramic protective coating on a substrate.

### DETAILED DESCRIPTION OF EMBODIMENTS OF THE INVENTION

Each of the embodiments of the invention described herein relate to a protective ceramic-containing coating, and a method of preparing the coating and applying it on substrates made of various materials, including metal, glass and ceramic. In one embodiment, a coating preparation is prepared by mixing materials that include filler particles, fine vitreous particles such as glass, a ceramic liquid such as a ceramic sol, and in some cases, a liquid carrier. Then, the preparation is deposited on the substrate by a suitable technique that includes spin-coating, dip-coating, spray-coating, painting or screen-printing. The coated substrate is then dried to remove the liquid component of the coating, and a sintering step is applied to fully develop a ceramic matrix in situu in the coating; that is, the coating is sintered at a sustained elevated temperature to cause solid particles of the ceramic sol precursor to interact with the glass particles to form a matrix of particles having a new ceramic composition. During the sintering heat treatment and the formation of the ceramic matrix, the filler material becomes integrated (i.e., develops an interfacial bond) with the ceramic matrix. The filler material may be one or a mixture of ceramic, glass, or metal particles.

In this description, the term “ceramic” refers to inorganic non-metallic man-made solid materials including, but not limited to metallic oxides (such as oxides of aluminum, silicon, magnesium, zirconium, titanium, chromium, lanthanum, hafnium, yttrium and mixtures thereof) and nonoxide compounds including but not limited to carbides (such as of titanium tungsten, boron, silicon), silicides (such as molybdenum disicilicide), nitrides (such as of boron, aluminum, titanium, silicon), silicates (such as borosilicate) and borides (such as of tungsten, titanium, uranium) and mixtures thereof; spinels, titanates (such as barium titanate, lead titanate, lead zirconium titanates, strontium titanate, iron titanate), ceramic super conductors, zeolites, and ceramic solid ionic conductors (such as yittria stabilized zirconia, beta-alumina and cerates).

According to a first embodiment of the invention, a protective ceramic coating comprises a selected composition of three constituent materials, namely, (a) finely-divided glass particles (“glass matrix component”), (b) solid ceramic material from a ceramic liquid precursor such as a ceramic sol (“ceramic precursor matrix component”), and (c) filler particles, and is prepared and applied onto a substrate according to one of two methods (methods P1 and P2).

A suitable glass matrix component is finely-divided lithium sodium borosilicate glass. However, other suitable glass materials will occur to one skilled in the art. For example, suitable glass compositions may include oxides from the list of SiO₂, Al₂O₃, B2O₃, P2O₃, ZrO₂, and TiO₂. In this embodiment, the average particle size of the lithium sodium borosilicate glass should be smaller than 5 μm and preferably smaller than 1.5 μm. The preferred compositional range of this glass is presented in Table 1:

TABLE 1
Base Glass Matrix Composition (Lithium Sodium Borosilicate)

| Component | Wt % |
|---|---|
| SiO₂ (silica) | 30-45 |
| Al₂O₃ (alumina) | 5-16 |
| B₂O₃(boric oxide) | 20-60 |
| Na₂O (sodium oxide) | 9-23 |
| Li₂O (lithium oxide) | 6-12 |

Up to 10 wt % additive oxides such as Fe, Ni, Co, V, Sb, P, Mn etc may be used over the base glass composition in Table 1.

The glass matrix component may be prepared by wet milling; in such case, any wet milling should be conducted in organic solvents such as ethanol, isopropanol, acetone and other suitable solvents as known in the art, in order to prevent ionic leaching from the surface of the glass particles.

A suitable ceramic precursor matrix component may be a ceramic sol chosen from the group of ceramic sols of alumina, silica, titania and zirconia, and mixtures of aqueous ceramic sols. However, other suitable ceramic sols and ceramic liquids will occur to one skilled in the art.

A suitable filler may be chosen from the group of solid ceramic particles, glass particles, and metallic particles. Suitable ceramic particles include oxide components—e.g. alumina, silica, titania, zirconia, magnesia spinel—or non oxide components—e.g. B₄C, BN, SiC, AlN, Sialon—or mixtures thereof. Suitable metallic particles include aluminum alloys, stainless steel and nickel alloys.

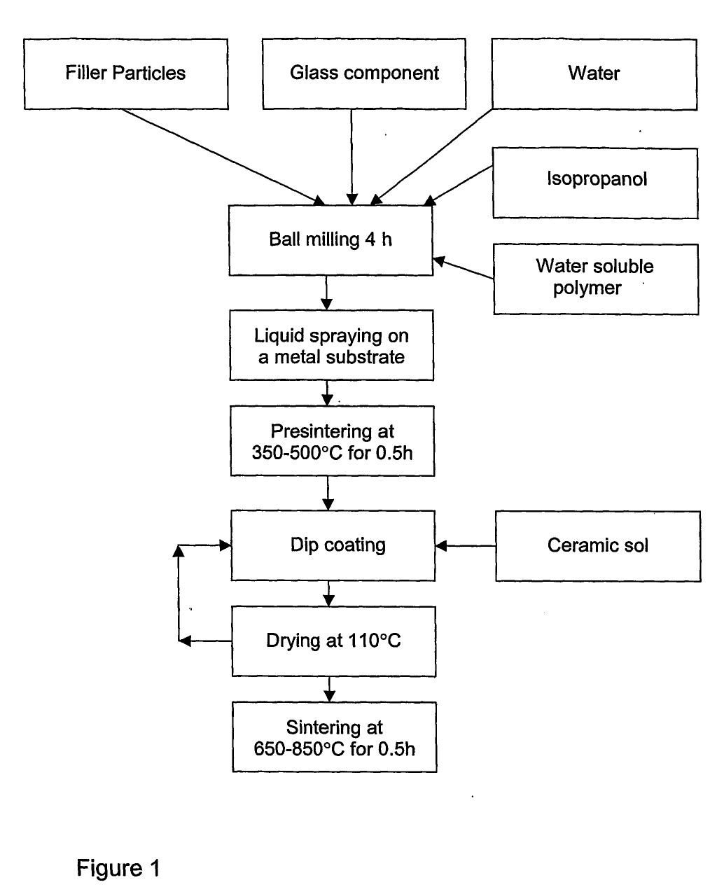

A first experimental method (“method P1”) of preparing a protective ceramic coating preparation and applying the preparation onto a substrate is illustrated in FIG. 1. The first step in this method involves forming a slurry by mixing together the filler particles and the finely-divided glass particles (used as the glass matrix component) in a liquid carrier suspension of water and isopropanol. Although exclusively water may be used as the liquid carrier, it is preferred to also include isopropanol or other volatile low surface tension solvents to provide improved rheological, dispersion and surface tension characteristics. Also, a water soluble polymer may be added to the mixture to increase the stability of coating suspensions and improve the strength of coating deposits before sintering.

The slurry mixture is then ball milled for about 4 hours. Ball milling is employed in this case as an intensive mixing method to ensure the homogeneity of the coating thereby producing slurry that has a consistency and viscosity suitable for spraying. Alternatively, other intensive mixing methods may be employed such as ultrasound homogenization, vibromilling etc.

Then, the slurry mixture is sprayed onto a target metal substrate. Spraying may be performed with a spray gun used for polymer mixes as is known in the art.

The coated substrate is then subjected to a pre-sintering heat treatment at a temperature and for a length of time sufficient to provide the coating with enough mechanical strength that the coating can be subsequently dip-coated in a liquid bath of ceramic sol. For example, thin coatings of up to about 1 mm may be suitably pre-sintered at 300-650° C. for about 30 minutes. Alternatively, the coating may be heated at temperatures up to 850° C. in which case some sintering of the coating may occur.

After pre-sintering, the coated substrate is dip-coated in a liquid bath of ceramic sol so that the ceramic sol penetrates the pores of the pre-sintered coating. Then, the coated substrate is then dried at about 110° C. until completely dry. This drying step removes the liquid component of the sol, immobilizing the solid component of the sol in the coating, if successive steps of sol penetration are applied or if the coated part is accidentally exposed to ambient humidity etc. For example, in coating parts with a relatively simple geometry, 10 minutes has been found to be a sufficient period to dry the part.

After drying, the coated substrate is subjected to a sintering treatment to cause the glass matrix component and the solid component of the ceramic sol (i.e. the ceramic precursor matrix component) to interact and form a ceramic matrix. A suitable sintering temperature and period is 550-850° C. and about 30 minutes when using finely-divided glass particles having an average particle size of 5 μm or less. Although the exact nature of the ceramic precursor/glass interaction is not fully understood, it is believed that at high temperatures (above the glass softening point) the glass particles incorporate at least partially in their composition the reactive phases resulting from the decomposition of the ceramic precursor, thereby producing a vitreous ceramic matrix having a new ceramic composition if the glass and ceramic precursor materials are fully interacted, or, compositionally-graded particles comprising a blend of glass and interacted glass and ceramic precursor material, if the glass and ceramic materials do not fully interact. Compositionally-graded particles are expected to develop as a result of larger glass particles not being able to fully incorporate the ceramic precursor material, thereby resulting in a core of glass and a surface layer of interacted glass and ceramic precursor material.

Prior to sintering, the dip-coating/drying steps may be repeated several times to deposit a suitable amount of ceramic sol in the pre-sintered mix of fillers and glass. A suitable amount of ceramic sol is that which avoids the formation of soft ceramic deposits after sintering (caused by too low a concentration of ceramic sol), and has a minimal shrinkage which causes no spalling.

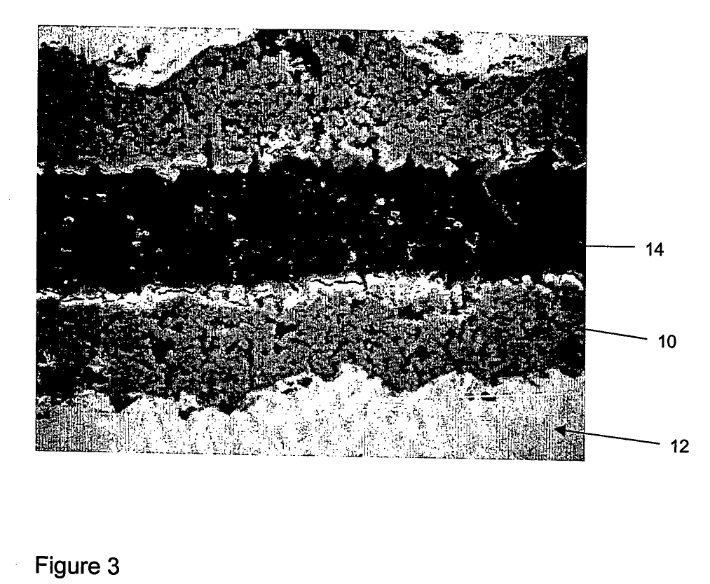

Referring to FIG. 3, the sintered coating 10 is adhered on the substrate 12 and exhibits a porous vitreous microstructure. (FIG. 3 shows two sample coated substrates 14 mounted to a sample mounting resin 14). The porosity of the coating varies between 15 and 60%. The sintered coating 10 provides thermal, corrosion and abrasion resistance comparable to ceramic coatings prepared by techniques known in the art.

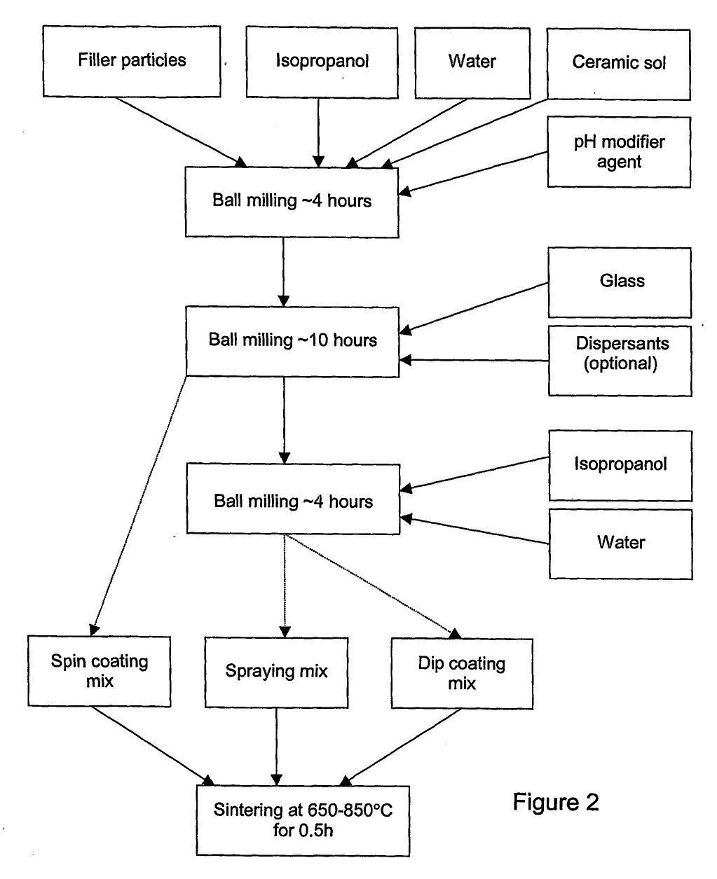

The ceramic sol may be applied to a pre-sintered mix of filler and glass matrix component as per method P1 just described, or alternatively, be added directly to the coating slurry without a pre-sintering step. This latter approach is illustrated in FIG. 2. In this method (“method P2”), the direct addition of the ceramic sol to the coating slurry provides good control of the ceramic sol content and consequently of the ceramic precursor/glass ratio that serve as the constituent components of the ceramic matrix.

The steps of carrying out method P2 are as follows: Filler (e.g. alumina particles), and a ceramic sol (ceramic precursor matrix component) are first mixed in a liquid carrier of water, organic solvent (e.g. isopropanol) and a pH modifier agent (e.g. ammonia solution) to form a preparation. If the ceramic sol is sufficiently dilute, then the liquid carrier of water and organic solvent may be omitted from the preparation. A sufficient amount of a pH modifier such as ammonia solution or glacial acetic acid is added to the preparation to prevent gelation of the sol. Special attention must be given to avoid gelation of the sol; if the sol gels in the coating slurry, before application on a substrate, it hinders the high temperature interaction that leads to the formation of the ceramic matrix and may cause high shrinkage and consequently massive cracking or complete spalling of the coating.

The preparation is then ball milled for about 4 hours, and then glass particles (glass matrix component) are added. Dispersants can also be added in order to increase stability of coating in suspension, and to improve coating uniformity on substrate. The glass matrix component is introduced after obtaining a homogeneous mix of ceramic precursor and ceramic filler in the preparation, in order to improve homogeneity and prevent the risk of gelling the ceramic sol.

Then, the mixture is ball milled for about 10 hours. The preparation is then applied a target substrate by a suitable coating method such as spin-coating. Alternatively, the preparation may be applied to the substrate by spraying or dip-coating. In such case, additional liquid carrier (water and isopropanol) is added to the preparation after the 2^{nd} ball milling session and before sintering to make the preparation dilute enough for spraying or coating. Then, the mixture is ball milled for about another 4 hours. Spin-coating and spraying are particularly desirable techniques because they generate good uniformity of the deposit. Dip-coating is desirable particularly in the case of deposition on porous substrates.

The coated substrate is subjected to a sintering treatment to cause the glass matrix component and the solid component of the ceramic sol (i.e. the ceramic precursor matrix component) to interact and form a ceramic matrix. A suitable sintering temperature and period is between 650-850° C. and about 0.5 hours, although it is possible to sinter at between 550 and 850° C.

The following Examples describe a number of experiments of coating a substrate with a ceramic coating according to one of methods P1 and P2. The matrix glass component in each of the experiments was one of the compositions of Lithium Sodium Borosilicate glass as specified in Table 2. However, other suitable forms of Lithium Sodium Borosilicate, or other types of glasses, may occur to one skilled in the art.

TABLE 2
Base compositions of matrix glass component (by wt. %)

| Component | Glass 1 | Glass 2 | Glass 3 |
|---|---|---|---|
| SiO₂ (silica) | 39.7 | 37.16 | 44.6 |
| Al₂O₃ (alumina) | 10.1 | 15.79 | 12 |
| B₂O₃ (boric oxide) | 29.5 | 57.29 | 22 |
| Na₂O (sodium oxide) | 12 | 19.71 | 14.3 |
| Li₂O (lithium oxide) | 8.7 | 9.22 | 7.1 |

### EXAMPLES

### Example A

### Base Coating 1 (BC1)

A coating slurry was prepared by method P1 by mixing 63 g of Alcan C94 alumina, 23.8 g Alcoa™ A16SGD alumina and 14 g Tosoh™ TZ-8Y zirconia as fillers with 6.25 g Glass 1 in 300 ml of water and 100 ml of isopropanol. Also, 40 ml of solution 5 wt % of Polyox® in water was used as the water soluble polymer. The slurry was ball-milled for 4 hours, and then sprayed on an Inconel 625 substrate, and presintered at 560° C. for 0.5 hours. After cooling to ambient temperature, the deposit was top-coated with a 0.5M Alumina ceramic sol in five dip-coating/drying cycles and sintered at 750° C. for 0.5 hours. The resulting base coating was examined and found to be porous, crack-free and had an average thickness of 35 μm.

### Example B

### Bass Coating 2 (BC2)

A coating slurry was prepared by method P1 by mixing log of Alcan C94 alumina, 40 g aluminum powder with average particle size of 5 μm, 10 g of UK Abrasives™ F1500 boron carbide powder, 23.8 g Alcoa™ A16SGD alumina and 14 g Tosoh TZ-8Y zirconia as fillers with 6.25 g Glass 3 in 300 ml of water and 100 ml of isopropanol. A water soluble polymer was used comprising 40 ml of solution 5 wt % of Polyox® in water. The slurry was ball milled for 4 hours then sprayed on an Inconel 625 substrate, and pre-sintered at 600° C. After cooling, the ceramic deposit was top coated with a 0.1 M zirconia ceramic sol in four dip-coating/drying cycles and sintered at 800° C. for 0.5 hours.

The resulting base coating was examined and found to be crack-free and have an average thickness of 30 μm. Microscopic observation showed that both aluminum and B₄C components showed a certain degree of oxidation. If avoiding oxidation of metallic or non oxide fillers is desired, the sintering can be conducted in protected atmosphere (such as Nitrogen, Argon etc.)

### Example C

### Base Coating 3 (BC3)

A coating preparation was prepared according to method P2 by mixing 93 g of Alcoa™ A300FI alumina and 93 g Alcoa™ A16SGD as fillers and 310 ml of isopropanol. A ceramic precursor matrix component of 10 ml of DuPont™ Ludox HS-40 ceramic sol was added directly to the preparation. For pH correction and in order to prevent the gelation of the sol, 20 ml of 2 wt % solution of ammonia in water was also added. The preparation was ball-milled for 4 hours and 62.5 g Glass 1 in 310 ml of water was added. No water soluble polymer addition or dispersant was used. The preparation was then ball milled for about 10 hours. Then, the preparation was applied on a stainless steel 316 substrate by spin coating and sintered at 710° C. for 0.5 hours.

Upon examining the coated substrate, it was observed that the resulting coating had a multitude of vertical micro-cracks and an average thickness of 200 μm. Such vertical micro-cracks in coating are expected to contribute some thermal stress resistance and an increased adhesion of the coating to the substrate.

### Example D

### Base Coating 4 (BC4)

A coating preparation was prepared using method P2 by mixing 93 g of Alcoa A3000FI alumina and 93 g Alcoa™ A16SGD as fillers and 310 ml of isopropanol. A ceramic precursor matrix component of 10 ml of DuPont Ludox™ HS-40 ceramic sol was added directly to the preparation. For pH correction and in order to prevent the gelation of the sol, 20 ml of 2 wt % solution of ammonia in water was added to the preparation. No water soluble polymer addition was used. Optionally, dispersants may be added at this stage. The preparation was ball milled for about 4 hours then 62.5 g of Glass 1 was added. Then, the preparation was ball milled again for about another 10 hours. Then, an additional 310 ml of water and 310 ml of isopropanol were added and the resulting preparation was ball milled for about 4′ hours then applied on a carbon steel 4130 substrate by spraying. The coating was then sintered at 680° C. for about 0.5 hours.

The resulting base coating was observed to have fine vertical micro-cracks and an average thickness of 40 μm.

### Example E

### Base Coating 5 (BC5)

According to method P2, a ceramic precursor solvent was prepared by mixing 10 ml Acetyl Acetone (99+% Alfa Aesar), 40 ml Ethyl Acetate (99.5+% Alfa Aesar), 120 ml Methyl Iso-Buthyl Ketone (99+% Alfa Aesar) and 40 ml Xylene (99+% Alfa Aesar). In addition to being the solvent for the ceramic sol, the solvent also serves as the liquid carrier for the filler and glass particles of the coating.

A pH Modifier (acidifier) of 0.3 ml Glacial Acetic Acid (99.99% Alfa Aesar) was added to the solvent. Then, temporary organic binders of: 5 ml Polyethylene Glycol (Alfa Aesar MW 600) and 5.6 g Polyvinyl Butyral resin (such as Butvar B 79 PVB) were added into the solvent mix under continuous agitation.

After a clear solution was obtained, a mix of ceramic precursor (solid component of the sol) was added under intense agitation. The mix was made of 11.5 ml Tetraethoxysilane (99% Alfa Aesar) and 16.2 ml Zirconium Propoxide (Aldrich 70% in n-propanol). After a clear solution was obtained, the organo-metallic compounds were hydrolyzed by the slow addition of small quantities of water in order to form a mixed organic based sol until the complete hydrolysis occurs for 2 moles of water per each mole of organo-metallic precursor respectively 6.3 ml water.

As known to those skilled in the art, in the case of solvent-based ceramic sols, small amounts of water above the amount required for complete hydrolysis may result in a partial gellation of the precursor solution. Therefore, when preparing a solvent sol it is very important to take into account the amount of water existing as an impurity in every solvent component of the mix.

A proper quality zirconia silica solvent base sol should be a clear yellow transparent liquid.

To the liquid component prepared as described above, a mixture of 58 g of Alcoa™ A3000FI alumina and 58 g Alcoa™ A16SGD as fillers and 36 g of Glass 1 was added and the resulting suspension was subjected to vibromilling for 4 hours, then was applied on a carbon steel 4130 substrate by spraying. The coating was then sintered at 680° C. for about 0.5 hours.

The resulting base coating was observed to be smooth with very few micro-cracks and had an average thickness of 50 μm.

According to another embodiment of the invention, the ceramic coating may be infiltrated by a sealant to form a composite sealant-ceramic coating that provides additional protective properties over the ceramic-only coating. Such sealant includes inorganic sealants and organic sealants.

The inorganic sealing process for forming the composite coating involves first applying a solution of inorganic solution over a ceramic coating prepared by one of methods P1 and P2. Suitable inorganic sealants include water soluble ceramic precursors such as solutions of sodium borate, boric acid, and mixed borophosphates or mixtures of ceramic sols and silica sol sodium borate, boric acid, and mixed borophosphates. The preferred methods of application of the inorganic sealant solution are dip-coating or spraying. The sealant solution penetrates the ceramic coating by entering through the open pores of the ceramic coating. Sufficient sealant is applied to provide a homogeneous penetration of the open pores beyond the surface layer. Then, a thermal treatment is applied at a temperature up to the sintering temperature of the base ceramic coating. For example, a suitable thermal treatment is heating at 470-800° C. for 30 minutes for simple shape parts. After sintering, mechanical bonding (at least interlocking) was found within most of the coatings between the sealant and the matrix particles. Chemical bonding may also occur, which is expected to positively further strengthen the sealant-coating interface.

The organic sealing process that forms the composite coating involves first applying organic polymers over the surface of a ceramic coating produced by one of methods P1 and P2, that has not already been sealed or partially sealed with inorganic compounds. Suitable polymers include fluoropolymers such as PTFE, PFA and FEP, low density polyethylene, Poly Ether Sulfone, Polyimide and epoxy resins. The polymer sealant may be applied by powder coating, spray-dip- or spin-coating onto the surface of the ceramic coating, to produce a composite coating. The polymer sealant penetrates the ceramic coating by entering through the open pores of the ceramic coating. Sufficient sealant is applied to provide a homogeneous penetration of the open pores beyond the surface layer. Then, the composite coating is thermally treated to cure the organic component of the coating. When the polymer sealant is applied as a deposit of solid particles on the surface of the ceramic coating, the infiltration is due to the melting of polymer particles which results in a liquid polymer layer that infiltrates the open pores of the ceramic matrix. Alternatively polymers solutions may be used by dissolving a polymer or a polymer mix in an appropriate solvent, in this case the infiltration is produced before the curing treatment. The thermal treatment depends on the specific polymer or polymer mix used and are the usual known curing treatments of those polymer or mixes of polymers, which are typically in the range of 250-340° C. for 10-30 minutes.

The following examples are experiments involving producing a composite coating comprising a base ceramic coating penetrated with an inorganic sealant:

### Example F

### Inorganic Sealant/Ceramic Composite Coating 1

Base coating BC1 was subjected to consecutive cycles of sealant penetration by dip-coating the base coating BC1 five times in a mixture of 0.25M zirconia sol and 10 wt % solution of borax in water. The sealant-penetrated ceramic coating was then dried. Then, the coating was subjected to a heat treatment step at 600° C. for 30 minutes. The sealing treatment resulted in a fully dense composite coating having a 400 Hv measured hardness.

### Example G

### Inomcanic Sealant Ceramic Composite Coating 2

Base coating BC1 was subjected to consecutive cycles of sealant penetration by dip-coating the base coating BC1 five times in a mixture of 5 wt % solution of sodium aluminum borophosphate. The penetrated coating was then dried and then cured at 470° C. The sealing treatment resulted in a porous ceramic coating with a 270 Hv hardness.

### Example H

### Inorganic Sealant/Ceramic Composite Coating 1

Base coating BC3 was subjected to 4 consecutive cycles of penetration by dip coating with a mix of 100 ml DuPont™ Ludox TMA, 100 ml of distilled water and 9.5 g boric acid and drying. The penetrated coating was then dried and then cured at 710° C. for 30 minutes. The sealing treatment resulted in a porous ceramic coating with a 210 Hv hardness.

The following examples are experiments involving producing a composite coating comprising a base ceramic coating penetrated with an organic polymer sealant

### Example I

### Organic Sealant/Ceramic Composite Coating 1

The inorganic sealant/ceramic composite coating produced in Example G was subjected to consecutive cycles of sealant penetration by dip-coating the base coating in a 5 wt % solution of Polyether Sulfone in N-Methyl Pyrolydone. The penetrated coating was then dried and then subjected to a heat treatment for 30 minutes at 300° C. The resulting composite coating was found to be fully sealed.

### Example J

### Organic Sealant/Ceramic Composite Coating 2

The surface of the inorganic sealant/ceramic composite coating produced in example I was sprayed with a 10 μm layer commercial polymer coating system (DuPont™ 958207) containing a mixture of FEP and Polyimide. The coating was then cured at 340° C. for 30 minutes, which melted the FEP, thereby enabling the polymer to penetrate the pores of the ceramic coating. The resulting sealant/ceramic composite coating was found to be completely sealed.

### Example K

### Organic Sealant/Ceramic Composite Coating 3

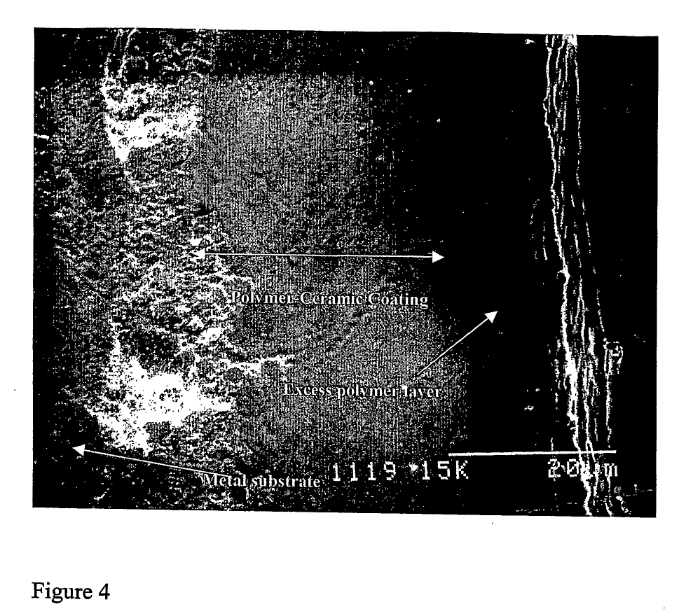

The surface of the base coating BC4 was top-coated with a layer of agglomerated FEP particles by an electrostatic powder coating method as known in the art. The coating was then cured at 340° C. for 30 minutes, which melted the FEP, thereby enabling the polymer to penetrate the pores of the ceramic coating. The resulting sealant/ceramic composite coating was found to be completely sealed. FIG. 4 shows a SEM cross-section view of this composite coating. On the top of the composite ceramic-polymer coating, a layer of excess polymer phase is observable. The composite coating consists of a mix of two continuous matrices of ceramic and polymer materials, the porous ceramic matrix being completely penetrated by a continuous polymer phase.

While the preferred embodiment of the invention has been illustrated and described, it will be appreciated that various changes can be made therein without departing from the scope and spirit of the invention.

What is claimed is:

1. A ceramic coating for protecting a substrate, comprising
(a) a ceramic matrix formed by a high temperature interaction between fine vitreous particles and the solid content of a ceramic liquid precursor; and
(b) a filler comprising one or more materials selected from the group of ceramic, glass, and metal particles, the filler being integrated in the matrix.

2. The ceramic coating of claim 1 wherein the fine vitreous particles are glass particles having an average particle size of 5 μm or less.

3. The ceramic coating of claim 2 wherein the glass particles of the matrix are selected from the group of lithium sodium borosilicate glass and glasses containing SiO₂ Al₂O₃, B₂O₃, P₂O₃, ZrO₂ and TiO₂.

4. The ceramic coating of claim 3 wherein the glass particles of the matrix are lithium sodium borosilicate glass containing up to 10 wt % additions of one or more oxides selected from the group of Fe, Ni, Co, V, Sb, P and Mn.

5. The ceramic coating of claim 1 wherein the ceramic liquid precursor is selected from the group of ceramic sols of alumina, silica, titania, zirconia, and mixtures thereof.

6. The ceramic coating of claim 1 wherein the filler material is selected from the group of ceramic particles consisting of alumina, silica, titania, magnesia spinel, B₄C, BN, SiC, AlN, Sialon, and mixtures thereof, and from the group of metallic particles consisting of aluminum, stainless steel, and nickel alloys.

7. A composite coating for protecting a substrate, comprising
(a) the ceramic coating of claim 1; and
(b) a sealant penetrating at least the surface layer of the ceramic coating.

8. The coating of claim 7 wherein the sealant is an inorganic material derived from a soluble ceramic precursor, the ceramic precursor being selected from the group of sodium borate, boric acid, mixed borophosphates, and, mixtures of ceramic sols and silica sols sodium borate, boric acid, and mixed borophosphates.

9. The coating of claim 7 wherein the sealant is an organic polymer containing at least one resin selected from the group of polytetrafluoroethylene, tetrafluoroethylene-perfluorovinyl ethers copolymers, fluorinated ethylenepropylene copolymers, low density polyethylene, poly ether sulfone, polyimide, and epoxy resins.

10. A method of producing a protective ceramic coating and applying the coating onto a substrate, the method comprising:
(a) forming a preparation by mixing together fine vitreous particles, a liquid carrier, and filler particles selected from the group of ceramic, glass, and metal particles, wherein the preparation excludes a sol;
(b) applying the preparation onto a substrate to form a coating on the substrate;
(c) heating the coating until the coating has sufficient integrity to be coated with a ceramic sol;
(d) applying a ceramic sol onto the coating such that the sol penetrates the pores of the coating; then
(e) heating the coating under conditions sufficient to cause an interaction between the fine vitreous particles and the solid component of the ceramic sol, thereby forming a ceramic matrix with filler particles integrated therein.

11. The method of claim 10 wherein in step (c), the coating is heated under conditions sufficient to provide the coating with enough mechanical strength for dip-coating, then, in step (d) the coating is dip-coated in a liquid bath of the ceramic sol so that the ceramic sol penetrates the pores of the coating.

12. The method of claim 10 wherein in step (a), the preparation is mixed until it is suitable for spraying, and in step (b), the preparation is sprayed on the substrate.

13. The method of claim 10 wherein in step (c) the preparation is heated at between 300-850° C.

14. The method of claim 10 wherein in step (e) the coating is heated at between 550-850° C.

15. The method of claim 14 wherein in step (e), the coating is heated at a temperature between 650-850° C. and under conditions sufficient to sinter the coating.

16. The method of claim 10 wherein the fine vitreous particles are glass particles having an average particle size of 5 μm or less.

17. The method of claim 16 wherein the glass particles of the matrix are selected from the group of lithium sodium borosilicate glass, and glasses containing SiO₂, Al₂O₃, B₂O₃, P₂O₃, ZrO₂, and TiO₂.

18. The method of claim 17 wherein the glass particles of the matrix are lithium sodium borosilicate glass including up to 10 wt. % additive oxides selected from the group of Fe, Ni, Co, V, Sb, P, and Mn.

19. The method of claim 10 wherein the ceramic sol is selected from the group of ceramic sols of alumina, silica, titania, and zirconia.

20. The method of claim 10 wherein the filler material is selected from the group of ceramic particles consisting of alumina, silica, titania, magnesia spinel, B₄C, BN, SiC, AlN, Sialon, and mixtures thereof, and from the group of metallic particles consisting of aluminum, stainless steel, and nickel alloys.

21. The method of claim 10 further comprising after step (e), applying a sealant onto the coating such that the sealant penetrates at least the surface layer of the coating, then, heating the coating at a temperature sufficient to bond the sealant to the ceramic matrix.

22. The method of claim 21 wherein the sealant is in solution form and is applied to the coating by one of dip-coating or spraying.

23. The method of claim 21 wherein the sealant is applied to the coating by one of powder coating, spray-coating, dip-coating, and spin-coating.

24. The method of claim 22 wherein the sealant is an inorganic material derived from a soluble ceramic precursor, the ceramic precursor being selected from the group of sodium borate, boric acid, mixed borophosphates, and, mixtures of ceramic sols and silica sols sodium borate, boric acid, and mixed borophosphates.

25. The method of claim 23 wherein the sealant is an organic polymer selected from the group of polytetrafluoroethylene, tetrafluoroethylene-perfluorovinyl ethers copolymers, fluorinated ethylene-propylene copolymers, low density polyethylene, poly ether sulfone, polyimide, and epoxy resins.

26. A method of producing a protective ceramic coating and applying the coating onto a substrate, the method comprising:
(a) forming a preparation by mixing together a ceramic sol, pH modifier agent, and filler particles selected from the group of ceramic, glass, and metal particles, the sol, modifier agent and filler particles being selected to avoid gelation of the sol;
(b) mixing in fine vitreous particles to the preparation;
(c) applying the preparation onto a substrate to form a coating on the substrate;
(d) heating the coating under conditions sufficient to cause an interaction between the fine vitreous particles and the solid component of the ceramic sol, thereby forming a ceramic matrix with filler particles integrated therein.

27. The method of claim 26 wherein the coating is heated at between 550-850° C.

28. The method of claim 27 wherein the coating is heated at between 650-850° C. under conditions sufficient to sinter the coating.

29. The method of claim 28 wherein the fine vitreous particles are glass particles having an average particle size of 5 μm or less.

30. The method of claim 29 wherein the glass particles of the matrix are selected from the group of lithium sodium borosilicate glass, and glasses containing SiO₂, Al₂O₃, B₂O₃, P₂O₃, ZrO₂, and TiO₂.

31. The method of claim 30 wherein the fine glass particles are lithium sodium borosilicate glass that includes up to 10 wt. % additive oxides selected from the group of Fe, Ni, Co, V, Sb, P, and Mn.

32. The method of claim 26 wherein the ceramic sol is selected from the group of ceramic sols of alumina, silica, titania, and zirconia.

33. The method of claim 26 wherein the filler material is selected from the group of ceramic particles consisting of alumina, silica, titania, magnesia spinel, B₄C, BN, SiC, AlN, Sialon, and mixtures thereof, and from the group of metallic particles consisting of aluminum, stainless steel, and nickel alloys.

34. The method of claim 26 wherein in step (c), the preparation is applied to the substrate by spin-coating.

35. The method of claim 26 further comprising in step (a), adding a liquid carrier to the preparation.

36. The method of claim 26 wherein between steps (b) and (c), a liquid carrier is applied to the preparation to dilute the preparation, then in step (c), the preparation is applied to the substrate by one of spraying or dip-coating.

37. The method of claim 26 further comprising after step (d), applying a sealant onto the coating such that the sealant penetrates at least the surface layer of the coating, then, heating the coating at a temperature sufficient to bond the sealant to the ceramic matrix.

38. The method of claim 37 wherein the sealant is applied to the coating by one of powder coating, spray-coating, dip-coating, and spin-coating.

39. The method of claim 37 wherein the sealant is an inorganic material derived from a soluble ceramic precursor, the ceramic precursor being selected from the group of sodium borate, boric acid, mixed borophosphates, and, mixtures of ceramic sols, sodium borate, boric acid, and mixed borophosphates.

40. The method of claim 38 wherein the sealant is an organic polymer selected from the group of polytetrafluoroethylene (PTFE), tetrafluoroethylene-perfluorovinyl ethers copolymers, fluorinated ethylene-propylene copolymers, low density polyethylene, poly ether sulfone, polyimide, and epoxy resins.

41. The coating of claim 1 wherein the solid content of the ceramic liquid precursor is a solid component of a ceramic sol.

42. The coating of claim 7 wherein the sealant comprises:
(a) an inorganic material derived from a liquid ceramic precursor, the ceramic precursor being selected from the group of sodium borate, boric acid, mixed borophosphates, and, mixtures of ceramic sols and silica sols sodium borate, boric acid, and mixed borophosphates; and
(b) an organic polymer containing at least one resin selected from the group of polytetrafluoroethylene, tetrafluoroethylene-perfluorovinyl ethers copolymers, fluorinated ethylene-propylene copolymers, low density polyethylene, poly ether sulfone, polyimide, and epoxy resins.
